(19) United States
(12) Patent Application Publication
(10) Pub. No.: US 2005/0032235 A1
(43) Pub. Date: Feb. 10, 2005

(54) Method of monitoring the blending of a mixture

(76) Inventors: Srinivas Tummala, Plainsboro, NJ (US); Ehrlic Lo, Green Brook, NJ (US); Simon Leung, Piscataway, NJ (US); San Kiang, Madison, NJ (US)

Correspondence Address: STEPHEN B. DAVIS;BRISTOL-MYERS SQUIBB COMPANY, PATENT DEPARTMENT, P O BOX 4000, PRINCETON, NJ, 08543-4000, US

(21) Appl. No.: 10/870,109

(22) Filed: Jun. 17, 2004

Related U.S. Application Data
(60) Provisional application No. 60/479,301, filed on Jun. 18, 2003.

(51) Int. Cl. G01N 21/62

(52) U.S. Cl. 436/171

(57) ABSTRACT

The present invention relates to a method of monitoring the blending of at least two blendable components to yield a mixture.

### RELATED APPLICATIONS

This application claims priority benefit under Title 35 § 119(e) of U.S. provisional Application No. 60/479,301, filed Jun. 18, 2003, the contents of which are herein incorporated by reference.

### FIELD OF THE INVENTION

The present invention relates to a method of monitoring the blending of two or more blendable components in a mixture wherein the state of blending including the onset of homogeneity or segregation can be detected in a rapid and reliable manner.

### BACKGROUND OF THE INVENTION

Close monitoring of the blending of components which are combined to form a mixture is essential, for example, to ensure that the resulting mixtures are homogenous, especially for the production of pharmaceutical compositions. Pharmaceutical compositions are typically composed of at least two components including pharmaceutically active components and non-active components, which are typically formed into a homogenous mixture prior to further processing (e.g., tableting). The components may be in the form of powders or fluents. The mixture is typically homogenous in that proper amounts or concentrations of the pharmaceutical active must be uniformly distributed throughout the pharmaceutical composition for administration to a patient. Ensuring the formation of homogenous mixtures and monitoring of the same can be a costly and time-consuming process.

It is important to ensure that the concentration of the non-active components (e.g., excipients) within the mixture is uniform since inconsistency of the non-active component can also adversely affect the quality and effectiveness of the final pharmaceutical composition. For example, disintegrants are often used in pharmaceutical compositions to determine the rate of dissolution of a tablet in a patient's stomach. Therefore, if the disintegrant is not uniformly distributed in the pharmaceutical mixture, the resulting tablets may not dissolve at a constant and predictable rate. This can adversely affect the quality, uniformity, dosing and bioavailability of the pharmaceutical composition. In addition to ensuring homogeneity, it is also important to minimize segregation or separation of the components that may occur due to particle size disparities and/or over blending.

Traditional methods for verifying homogeneity in a mixture are expensive, time-consuming and labor intensive. Traditional methods frequently result in delays in production runs until the analysis of the homogeneity of the mixture is completed prior to further processing which may run up to 48 hours. The traditional analysis usually involves extracting multiple samples from different portions of the mixture. The extracted samples are then analyzed using High Performance Liquid Chromatography (HPLC) techniques. The HPLC analysis determines the concentration of the active component in each of the samples. The results determine whether the active component is uniformly dispersed in the mixture in order to ensure proper concentration levels (i.e., a homogenous mixture). However, such analysis does not establish the concentration of the non-active components of the mixture and therefore while the active component may be uniformly distributed in the pharmaceutical composition, the non-active components may not. Homogeneity of all the components of a pharmaceutical mixture is important because the distribution of certain components may affect the physical properties of the final form of the pharmaceutical composition.

Recent methods and apparatuses have been developed to shorten the length of time to complete the analysis and permit monitoring to be performed in real-time without interrupting production especially during blending of the various components. Such methods and apparatuses substantially reduce the down-time and expense that are the principal drawbacks of the traditional monitoring process.

Such methods, including light-induced fluorescence (LIF) and infrared absorption spectroscopy such as near infrared spectroscopy (NIRS), typically involve observing spectrometric emissions emanating from the mixture to produce a response in the form of a spectrum or spectrograph. Each compound has a unique spectrum associated therewith. The spectrum is typically generated by exposing the mixture to a detectable radiation typically in the form of light and observing the radiation emitted back from the mixture, typically by use of a spectrometer. When using light as a source of radiation, each substance inherently absorbs and reflects light at one or more fairly specific wavelengths resulting in a unique fingerprint or spectrum. The spectrum may be used to observe the changes that occur as the mixture is blended from a loosely mixed form into a homogenously dispersed form.

In particular, light-induced fluorescence (LIF) spectroscopy generally relies on the presence of compounds capable of emitting fluorescence under specific conditions in a mixture. The LIF spectroscopic technique is generally limited to detecting the overall combined fluorescence intensity of the mixture, and thus lacks the resolution necessary to discern the distribution of individual components of the mixture in a reliable manner. In addition, since the technique is useful for determining whether a fluorescent component is uniformly distributed, it provides little information as to the distribution of non-fluorescent components which may be present in the mixture and thus the technique is able to detect uniformity of the fluorescent active component, but not the distribution of other components which are not fluorescent.

Near infrared (NIR) spectroscopy is generally based on the observation that molecular vibrations occur in the infrared region of the electromagnetic spectrum and functional groups have characteristic absorption frequency. The spectrum includes a graph showing absorption overtones and combinations of such overtones yielding absorption bands plotted against wavelength or frequency. The absorption bands typically extend over a broad range of wavelengths or frequencies, and thus are relatively difficult to analyze and obtain useful information concerning changes in the distribution of the individual components in the mixture.

However, both techniques are used to provide useful indicators that a mixture is homogenously blended. During the blending of two or more components, the initial spectrum will be similar to the individual spectrum of each of the individual components of the mixture. As the components are mixed, the spectrum begins to undergo changes over time, which indicates a more highly dispersed distribution of the components within the mixture. As mixing continues, the spectrum observed for the mixture converges towards a static or steady-state condition whereby changes in the spectrum are no longer observed over a predetermined period of time. When the spectrum reaches this steady-state condition, all of the components are assumed to be uniformly dispersed and thus in the form of a homogenous mixture.

The above techniques are used to merely observe changes in the spectrum during blending to determine whether a homogenous mixture is obtained. Such techniques may erroneously indicate a mixture to be homogenous when one portion of the mixture may become static (i.e., homogenous) while the remainder of the mixture is non-homogenous. In addition, the techniques described above are limited to observing overall changes to the spectrum of the mixture and thus fail to provide an accurate assessment of the state of blending of each individual component in the mixture.

It would therefore be a significant advance in the art of monitoring of blending of at least two blendable components to provide methods, which can detect the extent to which blending has occurred for multiple components of a mixture. It would be desirable to provide a method of monitoring and detecting the state of blending of components that can be implemented using commercially available equipment in a simple and cost-effective manner. It would be further desirable to provide a method of monitoring and detecting the state of blending of components that can provide a rapid and reliable indication of when a homogenous mixture is obtained.

### SUMMARY OF THE INVENTION

The present invention is generally directed to methods of monitoring and detecting the blending of at least two blendable components to form a mixture. The methods of the present invention facilitate the rapid and reliable confirmation of the state of the blendable components and the mixture formed by such components including whether a homogenous mixture has formed or the components have become segregated. The methods of the present invention may further be implemented in a rapid, accurate and non-invasive manner, while enhancing overall cost-effectiveness and efficiency to the production of mixtures, including homogenous mixtures.

Further, the methods of the present invention provide enhanced accuracy and reliability in monitoring and detecting the state of the blendable components, including reliably determining the existence of a homogenous mixture, while advantageously reducing disruptions in the production process frequently associated with prior methods. In addition, the methods of the present invention detect the onset of segregation of components that may occur due to particle size disparities and/or over blending. The methods of the present invention are especially useful, but not limited to, applications in the pharmaceutical industry.

In accordance with one aspect of the present invention, there is provided a method of monitoring the blending of at least two blendable components with at least two of the blendable components having different peak spectra, which comprises:
a) blending the at least two components in a vessel to form a mixture;
b) generating a sample spectrum of the mixture;
c) measuring the area of the peak spectra of the at least two components having different peak spectra in the sample spectrum;
d) comparing at least one ratio of the areas of the peak spectra of the at least two components having the different peak spectra of the sample spectrum with the corresponding ratio of the same components from a target spectrum of a known standard mixture, and when a predetermined match of the ratios is obtained, discontinuing the blending step; and
e) optionally continuing to blend the at least two components and repeating steps (b) through (d) until a predetermined match of the ratios is obtained.

In a particular aspect of the present invention, there is provided a method of monitoring the blending of at least two blendable components with at least two of the blendable components having different peak spectra, which comprises:
a) generating a component spectrum of each component of the mixture and identifying at least one frequency range associated with the component in the component spectrum;
b) blending the at least two components in a vessel to form a mixture;
c) generating a sample spectrum of the mixture;
d) measuring the area of the peak spectra of the at least two components having different peak spectra in the sample spectrum;
e) comparing at least one ratio of the areas of the peak spectra of the at least two components having the different peak spectra of the sample spectrum with the corresponding ratio of the same components from a target spectrum of a known standard mixture, and when a predetermined match of the ratios is obtained, discontinuing the blending step; and
f) optionally continuing to blend the at least two components and repeating steps (c) through (e) until a predetermined match of the ratios is obtained.

### BRIEF DESCRIPTION OF THE DRAWINGS

The following drawings are illustrative of embodiments of the present invention and are not intended to limit the invention as encompassed by the claims forming part of the application.

FIG. 1 illustrates an apparatus used for implementing the study of Example 1 in accordance with the present invention; and

FIG. 2 is a spectrum of a mixture containing four components described in Example 1 in accordance with the present invention.

### DETAILED DESCRIPTION OF THE INVENTION

The present invention relates generally to methods of monitoring the blending of at least two blendable components with at least two of the blendable components having different peak spectra. The methods of the present invention provide continuous real-time monitoring of the blending operation in a cost efficient and effective manner using commercially available blending equipment and spectrometric instruments. The methods of the present invention further provide enhanced accuracy and reliability in monitoring and detecting the status of the blending of components of the mixture including onset of homogeneity or segregation of the components in a mixture, while avoiding disruptions and delays in the production runs frequently associated with prior art methods. The methods of the present invention are especially useful for applications in the pharmaceutical industry.

Generally, the present invention provides a method of monitoring the blending of at least two blendable components with at least two of the blendable components having different peak spectra, which comprises:
a) blending the at least two components in a vessel to form a mixture;
b) generating a sample spectrum of the mixture;
c) measuring the area of the peak spectra of the at least two components having different peak spectra in the sample spectrum;
d) comparing at least one ratio of the areas of the peak spectra of the at least two components having the different peak spectra of the sample spectrum with the corresponding ratio of the same components from a target spectrum of a known standard mixture, and when a predetermined match of the ratios is obtained, discontinuing the blending step; and
e) optionally continuing to blend the at least two components and repeating steps (b) through (d) until a predetermined match of the ratios is obtained.

The term “components” generally refer to discrete blendable parts of a mixture which may be selected from any blendable materials. Such blendable materials include, but are not limited to, powders, particulates, fluents such as liquids, and the like.

As used herein, the terms “homogenous” or “homogeneity” refers generally to a state of blending in which the discrete components are uniformly distributed within the mixture of components.

As used herein the term “segregation” refers generally to a state blending in which a mixture of discrete components aggregates or separates resulting in a non-uniform distribution of components within the mixture. Segregation of components in a mixture typically occurs when the mixture is over blended and/or there are particle size disparities between the components.

As used herein, the term “spectrum” or “spectrograph” refers generally to a response detected by a spectrometer for a particular compound or mixture of compounds, showing a range of electromagnetic energies of specific intensities typically in the form of peaks, bands or markers arrayed in order of increasing or decreasing wavelength or frequency.

Although the present invention may be utilized principally to ensure adequacy of blending to yield a substantially homogenous mixture, the present invention is not limited to such use and may be used to detect other states of blending, including segregation, in accordance with the present invention.

In one embodiment of the present invention, there is provided a method of detecting the distribution of blendable components within a mixture including the onset of homogeneity or segregation of the components. The present method may employ any spectroscopic means including, but not limited to, light-induced fluorescence spectroscopy, near infrared spectroscopy or Raman spectroscopy. The preferred means of detecting the distribution of blendable components is through the use of Raman spectroscopy.

Raman scattering or spectroscopy is a light scattering technique that is used to identify the internal structure of molecules and crystals. The spectrum produced by Raman spectroscopy is generally composed of several sharp peaks or markers. In complex molecules, the various peaks may merge to form complex bands. The shapes of the bands can be used as a signature of the composition of matter. Raman spectroscopy is capable of detecting and distinguishing the presence of individual components in a mixture, thus allowing each of the components to be individually observed. The response or spectrum produced through Raman spectroscopy is typically characterized by sharp peaks or signals that are distinct and easily identifiable, which significantly enhances the ability to identify the distribution of the blendable components in the mixture for subsequent analysis.

The method of the present invention generally includes generating a component spectrum of each of a select group of individual components in the mixture using a conventional spectrometer, which is capable of directing radiation to the mixture, and collecting the reflected or scattered radiation (depending on the spectrographic technique used) to generate the necessary spectra useful for analyzing compositions of matter including mixtures of components. In one preferred embodiment, the conventional spectrometer is a Raman spectrometer. An example of a Raman spectrometer is Kaiser Optical RamanRXN™ System manufactured by Kaiser Optical Systems, Inc. of Ann Arbor, Mich. The selection of the components for analysis preferably is for components which have a unique component spectrum which does not significantly overlap the component spectra of the other select components used for the analysis of the mixture.

Each of the generated component spectra is composed of a unique series of peaks of varying intensity energy levels with each peak extending over a specific frequency range. The generated component spectra of the select components are compared to one another to identify specific frequency ranges in which a peak is occupied exclusively by one component. Thus, each identified frequency range represents a particular component. In this manner, when a spectrum is taken from a mixture, any response detected within an identified frequency range is attributed to the presence of the component having the particular frequency range.

The following is a representative example of a pharmaceutical mixture containing multiple components and their corresponding frequency ranges. The pharmaceutical mixture includes microcrystalline cellulose having a mutually exclusive peak at from about 369.3 cm⁻¹ to about 389.1 cm⁻¹; lactose monohydrate having a mutually exclusive peak at from about 335.7 cm⁻¹ to about 368.4 cm⁻¹ and at from about 341.0 cm⁻¹ to about 367.4 cm⁻¹; crospovidone having a mutually exclusive peak at from about 1214.4 cm⁻¹ to about 1249.3 cm⁻¹; polyethylene glycol having a mutually exclusive peak at from about 1471.9 cm⁻¹ to about 1504.9 cm⁻¹ and at from about 1269.9 cm⁻¹ to about 1289.0 cm⁻¹; magnesium stearate having a mutually exclusive peak at from about 1288.5 cm⁻¹ to about 1302.4 cm⁻¹; and atazanavir having a mutually exclusive peak at from about 797.0 cm⁻¹ to about 825.7 cm⁻¹. In this example, a signal response in the spectrum of the mixture at a frequency range of from about 1471.9 cm⁻¹ to about 1504.9 cm⁻¹ indicates the presence of polyethylene glycol at the portion scanned by the spectrometer.

Once the frequency ranges are identified for each of the components, the components are combined for blending in a vessel of a conventional blender. The conventional blender may be selected from any suitable type of blenders or mixers that are currently used in the art for blending pharmaceutical compositions including those outfitted with agitators located inside the vessel, such as blades or stirrers, for blending the components in the mixture. Such blenders may include ribbon blenders, core blenders, bin blenders and the like. One preferred type of blender is known as a “V”-blender. An example of a suitable blender or mixer is P-K Twin Shell® V-Blender manufactured by Patterson-Kelly Company of East Stroudsburg, Pa.

The vessel may be modified to allow remote or non-invasive monitoring of the mixture contained therein, thus avoiding the down time in the blending operation typically associated with traditional methods. Alternatively, the vessel may be modified to allow invasive monitoring, i.e., by having a probe through the shaft along the axis of rotation. The vessel is typically composed of a variety of suitable materials such as metals (e.g., stainless steel and hastealloy), or glasses (e.g., borosilicate, sapphire or quartz) or similar material depending on the wavelength region of the radiation being transmitted by the conventional spectrometer, which can be rotated at various speeds. Alternatively, the vessel may be adapted to include sampling ports or windows for permitting the spectrometer to monitor the blending operation through non-contact probes. The windows may be composed of a light transmissible material including glass such as borosilicate, quartz or sapphire.

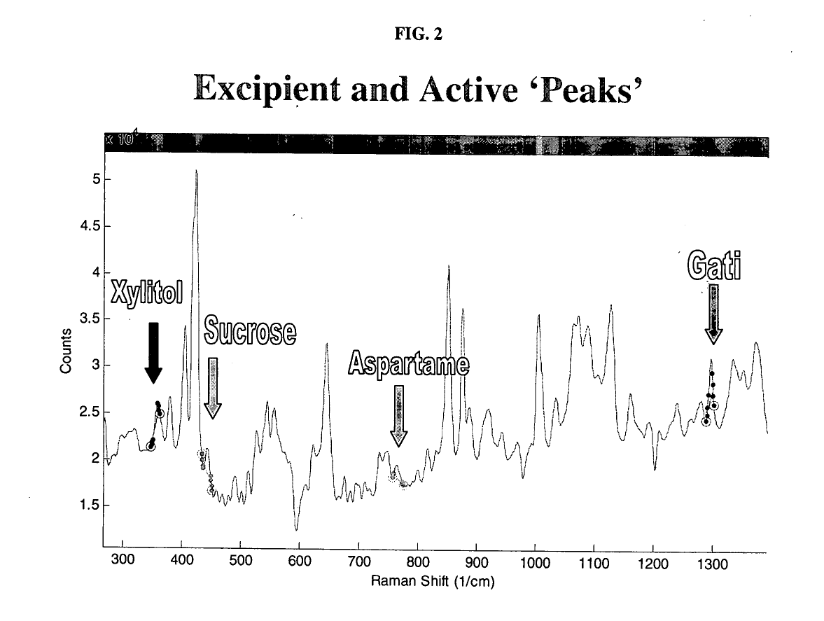

As the components are blended, a sample spectrum of the mixture is generated by the spectrometer. An example of a sample spectrum is shown in FIG. 2. The mixture may be periodically scanned by the spectrometer to generate a sample spectrum at a rate of about 1 spectrum every four minutes to about 5 spectra every second, and preferably from about 1 spectra per second to about 5 spectra per second. Initially, the sample spectrum exhibits a pattern similar to the component spectrum of one of the individual components in the mixture. As the blending proceeds, the sample spectrum reveals the peak spectra of the other components as the components disperse throughout the mixture. The sample spectra are each analyzed continuously in real-time.

In one embodiment of the present invention, the method comprises measuring the area of the peak spectra bounded under the spectral response curve within each of the frequency ranges previously selected. The term “area” as used herein refers to the graphical area bounded at the sides by the frequency endpoints of the frequency range for the individual component, at the bottom by the abscissa and at the top by the spectral response curve of the sample spectrum. The next step of the method includes determining the ratio of the respective areas of the peak spectra of any combination of components. It is preferable to select at least one ratio of peak spectra areas, more preferably at least two ratios of areas and most preferably at least three ratios of areas. The preferred comparison of the ratio of areas should compensate for changes in the spectrum that may occur due to differences in the characteristics of the mixture at different locations in the mixture. For example, the density of the mixture may be different at the upper portion of the mixing vessel than the bottom portion of the mixing vessel. Although the density may be different, the ratios of areas when computed from scans taken at both locations in the mixing vessel should be the same or at least very similar.

The ratio of areas of the sample spectrum is compared with the corresponding ratio of areas of a target spectrum generated from a known mixture containing the same components in a particular state of blending (e.g., homogenous or segregated). If the ratio of areas of the sample spectrum is the same as the target known mixture, the mixture is determined to possess similar state of blending characteristics as the target mixture. Thus, if the target mixture is a homogenous mixture, the sample mixture will be a homogenous mixture.

The method of the present invention may employ a computer to receive, display, analyze and/or store the spectra generated by the spectrometer. The computer may be further programmed to synchronize the series of spectra generated by the spectrometer. The series of spectra generated may be collected, manipulated, stored and displayed by software programs such as HoloGRAMS™ ver. 4.0 available from Kaiser Optical Systems, Inc. The computer may be further programmed to perform mathematical analysis that may be required for determining the state of blending (e.g., onset of homogeneity or segregation) in the mixture through software programs for analyzing the spectra such as Holoreact™, a proprietary Matlab-based software program available from Kaiser Optical Systems, Inc.

The state of blending may be determined through the analysis process described above using pre-calculated models, or by comparing the spectrum of the mixture with a target spectrum of a mixture known to possess a specific state of blending. The data transmitted from the spectrometer to the computer may be performed though wired or wireless data transfer means as known in the art.

### EXAMPLE 1

### Method for Producing a Standard Homogenous Mixture

The following procedure provides a method for creating a standard homogenous mixture from which subsequent sample mixtures may be compared to determine whether the sample mixtures are homogenously blended. In this example, a Raman spectrometer was used to non-invasively monitor the blending of a mixture containing four components. The four components were xylitol, sucrose, aspartame, and gatifloxacin. A small scale bin blender was prepared for blending the components together. The bin blender included a blending vessel having an optical port composed of sapphire to enable remote monitoring. A Raman spectrometer equipped with a 5.5 inch focal length non-contact probe was arranged adjacent to the bin blender with the non-contact probe directed at the sapphire optical port. The Raman spectrometer and non-contact probe were acquired from Kaiser Optical Systems, Inc.

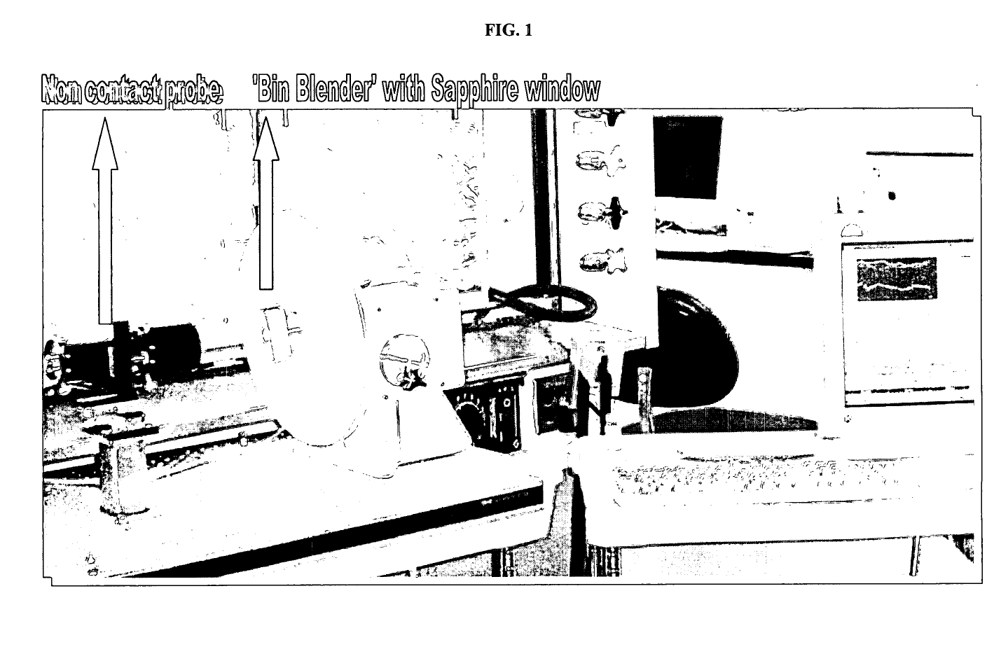

A computer was prepared and connected for receiving spectral data from the Raman spectrometer for subsequent analysis. The computer was loaded with HoloGRAMS™ software programmed for collecting, organizing, manipulating and displaying the spectra generated from the data acquired by the spectrometer. Subsequent mathematical analysis of the spectra was implemented by Holoreact™ software, both software programs are available from Kaiser Optical Systems, Inc. The experimental setup used to implement this procedure is shown in FIG. 1.

A component was separately loaded into the bin blender to generate a corresponding component spectrum of the component. The process was repeated for each component. The component spectra of the components were compared to one another to identify frequency ranges exclusive to each component. The following frequency ranges were identified for the components as listed in Table 1.

TABLE 1

| Component | Frequency Range |
|---|---|
| Xylitol | 347-362 cm⁻¹ |
| Sucrose | 433-451 cm⁻¹ |
| Aspartame | 755-777 cm⁻¹ |
| Gatifloxacin | 1289-1301 cm⁻¹ |

As shown in Table 1, each of the frequency ranges is distinct from the others so that each component may be used in the comparison of the ratio of areas of the peak spectrum.

Once the frequency ranges are identified, the components were combined and blended in the bin blender. During the blending, the spectrometer was preset to periodically collect the spectrum of the mixture and downloaded it into the computer to yield a successive series of spectra. After each download, the computer was programmed to analyze the spectra at the frequency ranges specified in Table 1. An example of one of the spectra collected from the mixture is shown in FIG. 2.

For each of the spectra obtained, the areas bounded by the spectral response curve and at the end points of the frequency ranges listed in Table 1 were measured for each component using the Holoreact software program. A ratio of the measured areas was calculated and monitored for each of the following pairs of components: xylitol and gatifloxacin; aspartame and gatifloxacin; and sucrose and gatifloxacin.

The blending was maintained until the ratios of areas remained within a predetermined standard deviation. At this point, the mixture was considered to be homogenously blended, and the corresponding ratios were recorded as a known standard by which subsequent mixtures will be compared to indicate a homogenous mixture.

### EXAMPLE 2

### Method of Determining the Homogeneity of Blendable Components Through Comparison With a Known Standard Mixture

Employing the same experimental as described in Example 1, the components consisting solely of xylitol, sucrose, aspartame, and gatifloxacin were added to the bin blender and blending was begun. The computer periodically collected the spectra of the mixture via the Raman spectrometer.

For each of the spectra obtained, the areas bounded by the spectral response curve and at the endpoints of frequency ranges listed in Table 1 are measured for each component using the Holoreact software program. A ratio of the measured areas is thereafter calculated and monitored for each of the following pairs of components: xylitol and gatifloxacin; aspartame and gatifloxacin; and sucrose and gatifloxacin.

To determine whether the mixture was homogenous, the calculated ratios of areas were compared to the known standard mixture of Example 1. When the match was achieved, further blending was terminated.

1. A method of monitoring the blending of at least two blendable components with at least two of the blendable components having different peak spectra, comprising:
a) blending the at least two components in a vessel to form a mixture;
b) generating a sample spectrum of the mixture;
c) measuring the area of the peak spectra of the at least two components having different peak spectra in the sample spectrum;
d) comparing at least one ratio of the areas of the peak spectra of the at least two components having the different peak spectra of the sample spectrum with the corresponding ratio of the same components from a target spectrum of a known standard mixture, and when a predetermined match of the ratios is obtained, discontinuing the blending step; and
e) optionally continuing to blend the at least two components and repeating steps (b) through (d) until a predetermined match of the ratios is obtained.

2. The method of claim 1 wherein the steps (b) through (d) are repeated until a homogenous mixture is obtained.

3. The method of claim 1 wherein the steps (b) through (d) are repeated until a segregated mixture is obtained.

4. The method of claim 1 further comprising generating a component spectrum of each component of the mixture and identifying at least one frequency range associated with the component in the component spectrum.

5. The method of claim 4 further comprising measuring the area of the peak bounded by the response curve, the abscissa and the frequency range endpoints at each of the at least one frequency range in the sample spectrum.

6. The method of claim 1 wherein step (b) is carried out by Raman spectroscopy.

7. The method of claim 4 wherein the component spectrum generating step is carried out by Raman spectroscopy.

8. The method of claim 1 further comprising comparing at least two ratios of the areas of the peak spectra of the at least two components.

9. The method of claim 1 further comprising comparing at least three ratios of the areas of the peak spectra of the at least two components.

10. A method of monitoring the blending of at least two blendable components with at least two of the blendable components having different peak spectra, comprising:
a) blending the at least two components in a vessel to form a mixture;
b) generating a sample spectrum of the mixture;
c) measuring the area of the peak spectra of the at least two components having different peak spectra in the sample spectrum;
d) comparing at least one ratio of the areas of the peak spectra of the at least two components having the different peak spectra of the sample spectrum with the corresponding ratio of the same components from a target spectrum of a known standard mixture, and when a predetermined match of the ratios is obtained, discontinuing the blending step; and
e) optionally continuing to blend the at least two components and repeating steps (b) through (d) until a predetermined match of the ratios is obtained.
